(19) United States
(12) Patent Application Publication
(10) Pub. No.: US 2019/0150414 A1
(43) Pub. Date: May 23, 2019

(54) Crab Trap Assembly

(71) Applicant: George Payne, Georgetown, DE (US)

(72) Inventor: George Payne, Georgetown, DE (US)

(21) Appl. No.: 15/816,244

(22) Filed: Nov. 17, 2017

(51) Int. Cl. A01K 69/08

(52) U.S. Cl. CPC A01K 69/08

(57) ABSTRACT

A crab trap assembly for capturing crabs includes a cylinder that may be inserted into a bottom of a body of water. The cylinder is substantially hollow to capture a crab when the crab moves along the bottom of the body of water and falls into the cylinder. The cylinder is selectively removed from the body of water to harvest the crabs in the cylinder.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to trap devices and more particularly pertains to a new trap device for capturing crabs.

### BRIEF SUMMARY OF THE INVENTION

An embodiment of the disclosure meets the needs presented above by generally comprising a cylinder that may be inserted into a bottom of a body of water. The cylinder is substantially hollow to capture a crab when the crab moves along the bottom of the body of water and falls into the cylinder. The cylinder is selectively removed from the body of water to harvest the crabs in the cylinder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a crab trap assembly according to an embodiment of the disclosure.

FIG. 2 is a top view of an embodiment of the disclosure.

FIG. 3 is a front view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

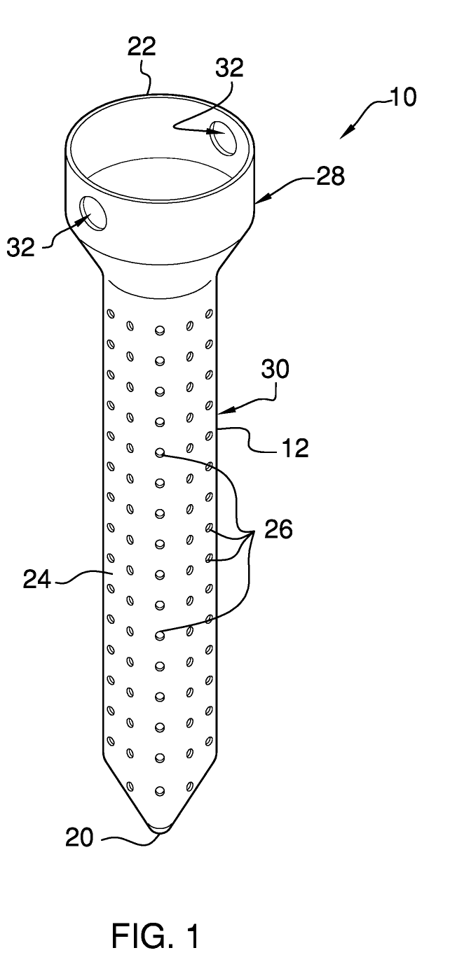

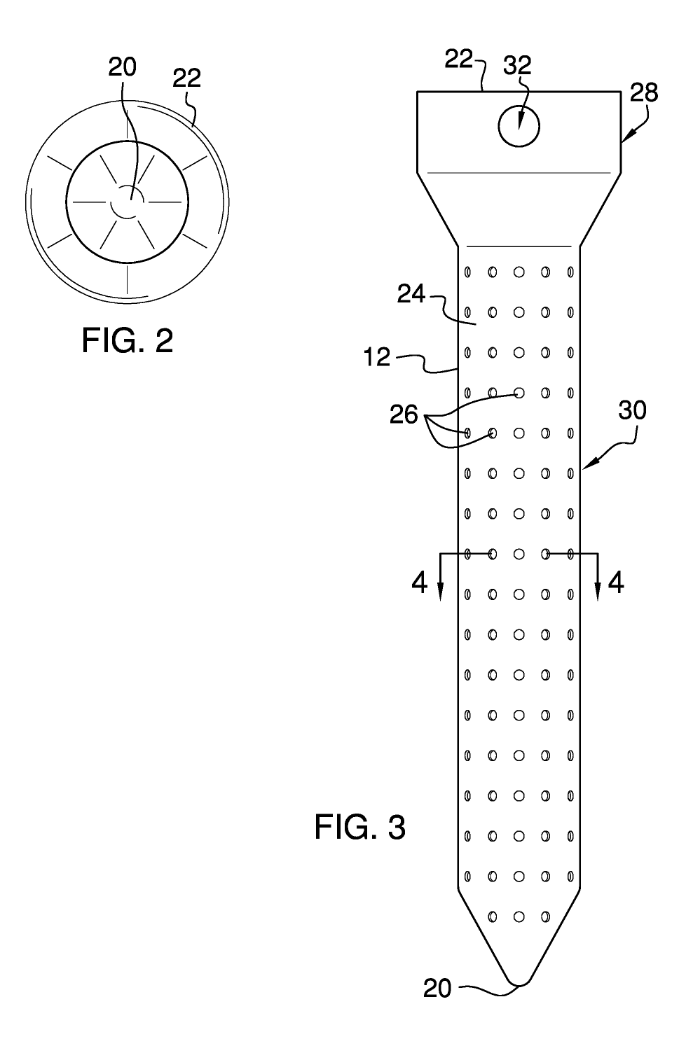

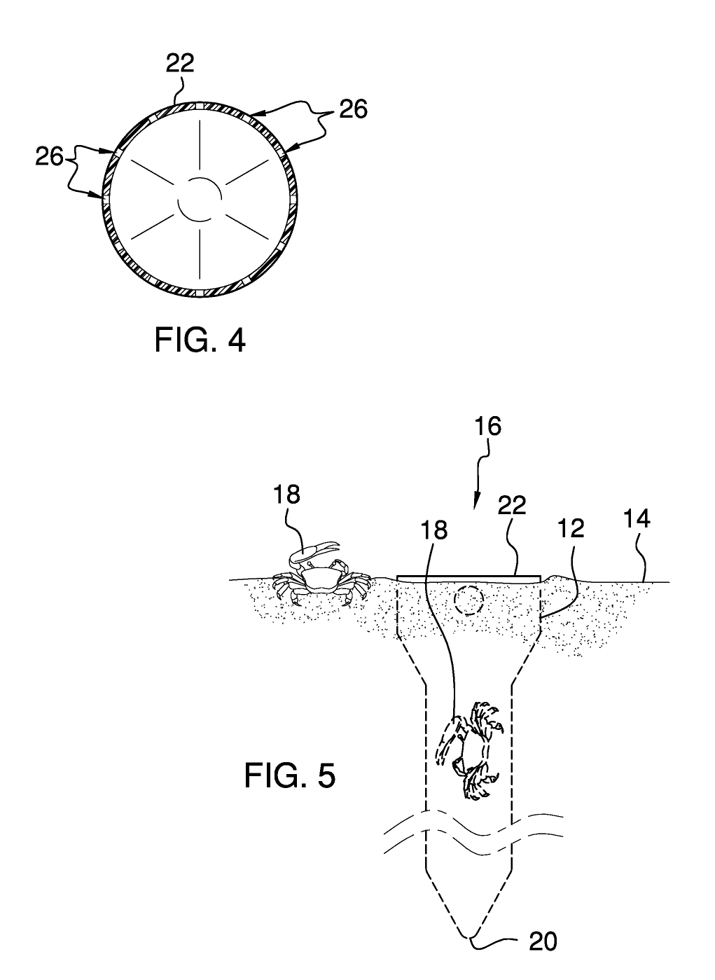

With reference now to the drawings, and in particular to FIGS. 1 through 5 thereof, a new trap device embodying the principles and concepts of an embodiment of the disclosure and generally designated by the reference numeral 10 will be described.

As best illustrated in FIGS. 1 through 5, the crab trap assembly 10 generally comprises a cylinder 12 that is selectively inserted into a bottom 14 of a body of water 16. The body of water 16 may be a salt water bay and any other body of water known to be populated with crabs. The cylinder 12 is substantially hollow to capture a crab 18 when the crab 18 moves along the bottom 14 of the body of water 16 and falls into the cylinder 12. The crab 18 may be a fiddler crab and any other crustacean not easily caught with nets and other conventional means of crab fishing.

The cylinder 12 has a first end 20, a second end 22 and an outer wall 24 extending therebetween. The first end 20 tapers to a point to pierce the bottom 14 of the body of water 16. The cylinder 12 is driven into the bottom 14 until the second end 22 is aligned with the bottom 14 of the body of water 16. The second end 22 is open such that the crab 18 falls into the cylinder 12 when the crab 18 walks over the second end 22.

The outer wall 24 has a plurality of first apertures 26 extending into an interior of the cylinder 12. Each of the first apertures 26 facilitates fluid to drain outwardly therefrom when the cylinder 12 is removed from the body of water 16. The outer wall 24 flares outwardly adjacent to the second end 22 to define a first half 28 of the cylinder 12 and a second half 30 of the cylinder 12. The first half 28 of the cylinder 12 has a diameter is greater than the diameter of a second half 30 of the cylinder 12.

Each of the first apertures 26 is positioned on the first half 28 of the cylinder 12. The outer wall 24 has a pair of second apertures 32 extending into the interior of the cylinder 12. Each of the second apertures 32 is gripped for removing the cylinder 12 from the bottom 14 of the body of water 16. Moreover, each of the second apertures 32 is positioned on the first half 28 of the cylinder 12.

In use, the first end 20 of the cylinder 12 is driven into the bottom 14 of the body of water 16 until the second end 22 of the cylinder 12 is aligned with the bottom 14 of the body of water 16. Additionally, the cylinder 12 is positioned in an area known to be populated with crabs 18. The crabs 18 fall into the second end 22 of the cylinder 12 when the crabs 18 walk over the cylinder 12. The cylinder 12 is upwardly outwardly from the bottom 14 of the body of water 16 at a selected time and the fluid drains outwardly though the first apertures 26. The crabs 18 in the cylinder 12 are dumped out and used for bait, food and any other purposes.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A crab trap assembly being configured to be positioned underwater thereby capturing crabs, said assembly comprising:
a cylinder being configured to be inserted into a bottom of a body of water, said cylinder being substantially hollow wherein said cylinder is configured to capture a crab when the crab moves along the bottom of the body of water and falls into said cylinder.

2. The assembly according to claim 1, wherein said cylinder has a first end, a second end and an outer wall extending therebetween, said first end tapering to a point wherein said first end is configured to pierce the bottom of the body of water having said second end being aligned with the bottom of the body of water, said second end being open wherein said second end is configured to have the crab fall therethrough.

3. The assembly according to claim 2, wherein said outer wall has a plurality of first apertures extending into an interior of said cylinder wherein each of said first apertures is configured to facilitate fluid to drain outwardly therefrom when said cylinder is removed from the body of water.

4. The assembly according to claim 3, wherein said outer wall flares outwardly adjacent to said second end to define a first half of said cylinder having a diameter being greater than the diameter of a second half of said cylinder, each of said first apertures being positioned on said first half of said cylinder.

5. The assembly according to claim 2, wherein said outer wall has a pair of second apertures extending into said interior of said cylinder wherein each of said second apertures is configured to be gripped for removing said cylinder from the bottom of the body of water, each of said second apertures being positioned on a first half of said cylinder.

6. A crab trap assembly being configured to be positioned underwater thereby capturing crabs, said assembly comprising:
a cylinder being configured to be inserted into a bottom of a body of water, said cylinder being substantially hollow wherein said cylinder is configured to capture a crab when the crab moves along the bottom of the body of water and falls into said cylinder, said cylinder having a first end, a second end and an outer wall extending therebetween, said first end tapering to a point wherein said first end is configured to pierce the bottom of the body of water having said second end being aligned with the bottom of the body of water, said second end being open wherein said second end is configured to have the crab fall therethrough, said outer wall having a plurality of first apertures extending into an interior of said cylinder wherein each of said first apertures is configured to facilitate fluid to drain outwardly therefrom when said cylinder is removed from the body of water, said outer wall flaring outwardly adjacent to said second end to define a first half of said cylinder having a diameter being greater than the diameter of a second half of said cylinder, each of said first apertures being positioned on said first half of said cylinder, said outer wall having a pair of second apertures extending into said interior of said cylinder wherein each of said second apertures is configured to be gripped for removing said cylinder from the bottom of the body of water, each of said second apertures being positioned on said first half of said cylinder.
